(19) United States
(12) Patent Application Publication
(10) Pub. No.: US 2022/0062769 A1
(43) Pub. Date: Mar. 3, 2022

(54) System and Method for Advertising Via Electronic Gaming

(71) Applicant: Ngage Sportek Ltd, Jerusalem (IL)

(72) Inventors: Gabriel Joseph Harkham, Raanana (IL); Uri Filiba, London (GB); Michael David Eisenberg, Encinitas, CA (US)

(73) Assignee: Ngage Sportek Ltd, Jerusalem (IL)

(21) Appl. No.: 17/045,931

(22) PCT Filed: Apr. 7, 2017
(86) PCT No.: PCT/US2017/026685

§ 371 Date: Aug. 9, 2021

(51) Int. Cl. A63F 13/61; G06Q 30/02; A63F 13/533; A63F 13/798

(52) U.S. Cl. CPC A63F 13/61; G06Q 30/0251; A63F 13/533; A63F 2300/558; A63F 2300/5506; A63F 2300/308; A63F 13/798

(57) ABSTRACT

A computer implemented method comprises: displaying an input interface that prompts a user for tournament data; receiving tournament data; displaying an input interface that prompts the user for scoreboard data; receiving scoreboard data; operating a computerized game tournament according to the tournament data; generating a customized tournament scoreboard, customized for the tournament being operated, according to the scoreboard data and data generated by the operation of the tournament; and dis playing player information on the customized tournament scoreboard.

### CROSS-REFERENCES TO RELATED APPLICATIONS

This application claims priority from U.S. Provisional Application Ser. No. 62/319,411 filed Apr. 7, 2017 which is hereby incorporated herein by reference in its entirety.

### TECHNICAL FIELD

The present invention, in some embodiments thereof, relates to electronic gaming, and more specifically for software and hardware for implementing social features for electronic gaming.

### BACKGROUND OF THE INVENTION

The field of electronic gaming relates to gaming for stationary and mobile computing devices, such as desktop and laptop computers, mobile phones, tablets, stationary and portable consoles.

Single player and multiplayer games are released daily for purposes of entertainment. Due to the pervasive nature of wired and wireless communications, player communities have been built around some multiplayer games, so that a social aspect has developed around electronic gaming

### BRIEF SUMMARY OF EMBODIMENTS OF THE INVENTION

An aim of the present invention is to enhance the social gaming experience for players, by creating tournaments with prizes. Another aim of the present patent application is to use these tournaments as advertising tools to enable sponsoring and advertising to engage with the players.

For this purpose, some embodiments of the present invention relate to a system for creating tournaments for electronic gaming devices, and for enabling advertisers to use such tournaments for advertising their brands, and/or products, and/or services.

In a variant, a customized scoreboard is generated for each computerized game tournament conducted.

In another variant, a computer implemented method comprises: displaying an input interface that prompts a user for tournament data; receiving tournament data; displaying an input interface that prompts the user for scoreboard data; receiving scoreboard data; operating a computerized game tournament according to the tournament data; generating a customized tournament scoreboard, customized for the tournament being operated, according to the scoreboard data and data generated by the operation of the tournament; and displaying player information on the customized tournament scoreboard.

In a further variant, the method further comprises generating a URL to point to the customized tournament scoreboard; and accessing the URL which causes the displaying of the customized tournament scoreboard on a local display system and/or a broadcast system.

In still another variant of the method, the player information comprises an image associated with the player, and a name associated with the player and a score achieved by the player in the operated tournament.

In yet a further variant of the method, the scoreboard data comprises at least one of a background image, prize image and sponsor image. The scoreboard data may optionally comprise an audio track.

In a variant, a computer implemented method comprises: displaying a first input interface that prompts a first user for tournament data; receiving tournament data; displaying a second input interface that prompts the first user for scoreboard data; receiving scoreboard data from the first user; displaying a third input interface that prompts a second user to input additional scoreboard data; receiving the scoreboard data and the additional scoreboard data;

operating a computerized game tournament according to the tournament data; generating a customized tournament scoreboard, customized for the tournament being operated, according to the scoreboard data and to the additional scoreboard and according to the data generated by the operation of the tournament; displaying player information on the customized tournament scoreboard.

In another variant, the method comprises generating a URL to point to the customized tournament scoreboard and accessing the URL which causes the displaying of the customized tournament scoreboard on a local display system and/or a broadcast system.

In a further variant, a computer implemented method comprises: operating an electronic tournament generator configured to receive tournament data. Tournament data may comprise, for example, prizes, venues, dates, in game, social media, mass media tournament, sponsor. The method comprises: characterizing some of the tournament data according to one or more metrics; operating a plurality of computer based game tournaments; receiving output data about players participating in the tournaments; storing the data into a database; prompting the user to select a metric; organizing the data according to a selected one of the metrics based on the data stored in the database; and generating a report that matches the selected metric to the output data metrics to the output data generated from the tournaments.

In some cases, either the tournament generator or a third party that has access to the data, characterizes some of the data according to certain metrics. For example, if a sports team has a tournament, and the people who created the tournament do not properly characterize the prizes, a third party, for example, an employee of the system, input the metric.

In still another variant of the method, the tournament data comprises one or more of: venue, prize, sponsor name and tournament type. Tournament type may be defined by where the tournament is made known or advertised to the public. For example, during a sporting event at the event, on a social media, a TV broadcast, the Internet.

In yet a further variant of the method, receiving output data comprises receiving the numbers of males and female players who played in the tournament, and the geographical locations of the players.

In a further variant, generating the report comprises returning counts for individual metrics to a user.

In another variant, the output data comprises any one or more of: number of players, scores, ranks, names/IDs, ages, profiles, sex, geographic location.

In a variant, the one or more metrics comprise any one or more of: type of prize, monetary value of the prize, venue's seating capacity, location of the venue, time of day of tournament, sponsor's industry type.

In yet a further variant, the method further comprises a plurality of users operating the tournament generator to generate a plurality of tournaments unique to each user, wherein the output data for each tournament is assessable to the respective user operating the specific tournament. Tournament data metrics are combined and the output data from the tournaments generated by the users, and a global report is generated and accessible to the users and containing the combined tournament data metrics and output data.

In still another variant, the metrics in the global report include one or more of: venue metric, prize metric, tournament type and sponsor metric.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIGS. 1A and 1B are block diagrams illustrating a system of the present invention for creating mobile gaming tournaments.

FIGS. 2A and 2B are block diagrams of a system of the present invention implemented in a server.

FIG. 3 is a block diagram illustrating the tournament administrator portal.

FIG. 4 is a block diagram illustrating the advertiser portal.

FIG. 5 is a block diagram illustrating details about the tournament creation module.

FIG. 6 is a diagram of an example of the basic data input module.

FIG. 7 is a block diagram illustrating the scoreboard creation module.

FIG. 8 is block diagram illustrating output from the promotion screen creation module for a tournament.

FIGS. 9-14 are screen views of final scoreboard screens with ads 499.

FIG. 15 is block diagram illustrating the game screen creation module.

FIGS. 16-18 show different screens of a game in which sponsor images are inserted.

FIG. 19 is a block diagram illustrating the creation of a dashboard.

FIG. 20 is a block diagram illustrating a dashboard module.

FIG. 21 is a calendar screen.

FIG. 22 is a screen showing different dashboards for the same date is opened.

FIG. 23 is a screen showing a graphical representation of the dashboard.

FIGS. 24 and 25 show respectively a tournament administrator report module and an advertiser report module.

FIG. 26 shows a tournament report, in which each tournament is associated with a respective window.

FIG. 27 is a prize report.

FIG. 28 is a venue report.

FIG. 29 is an advertiser report.

FIG. 30 is a block diagram showing the processing of data from different advertisers/venues to create global data reports that can be provided to all tournament administrators and advertisers.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

Before describing embodiments of the present application, it should be understood that the term “tool”, “utility”, and “module” refer to a unit including software and/or hardware elements configured for performing one or more functions.

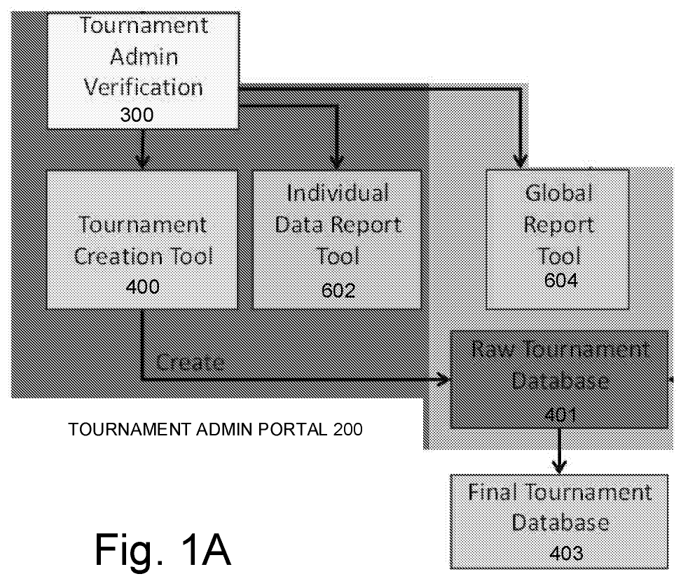

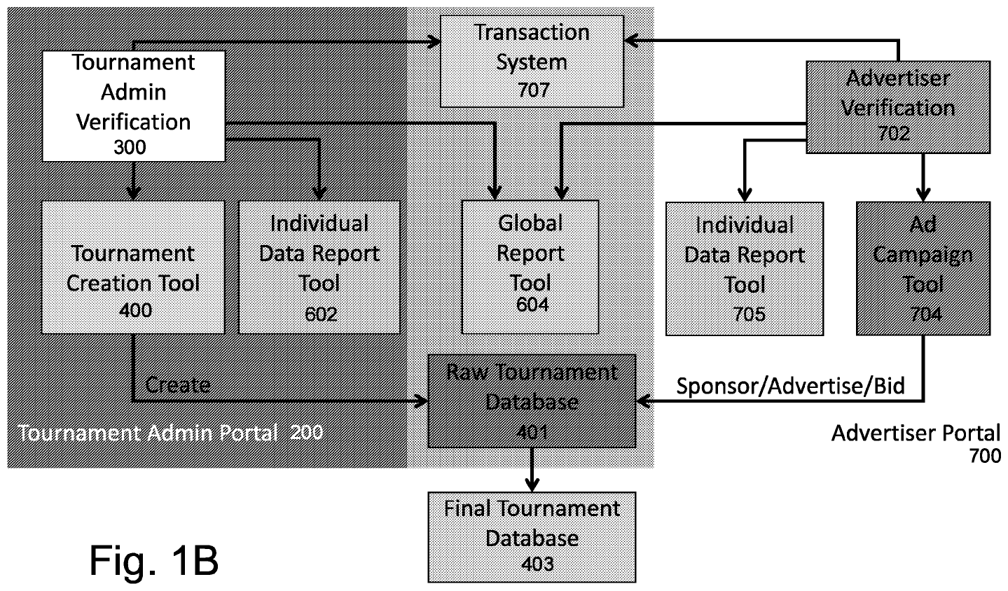

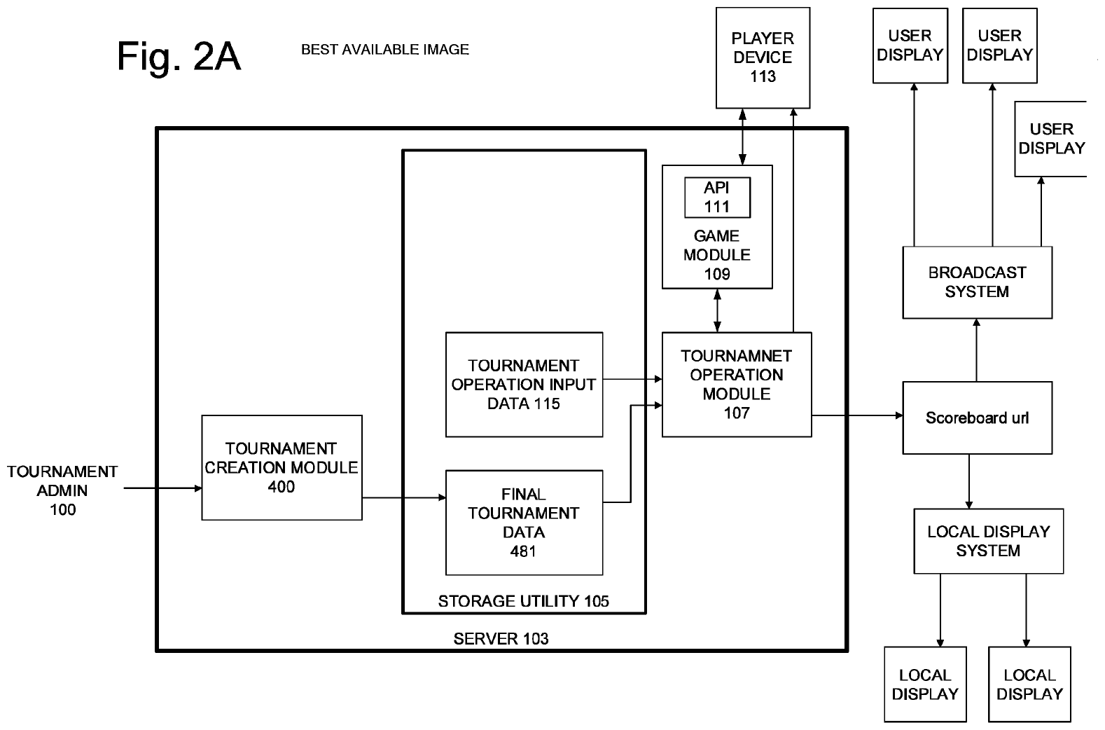

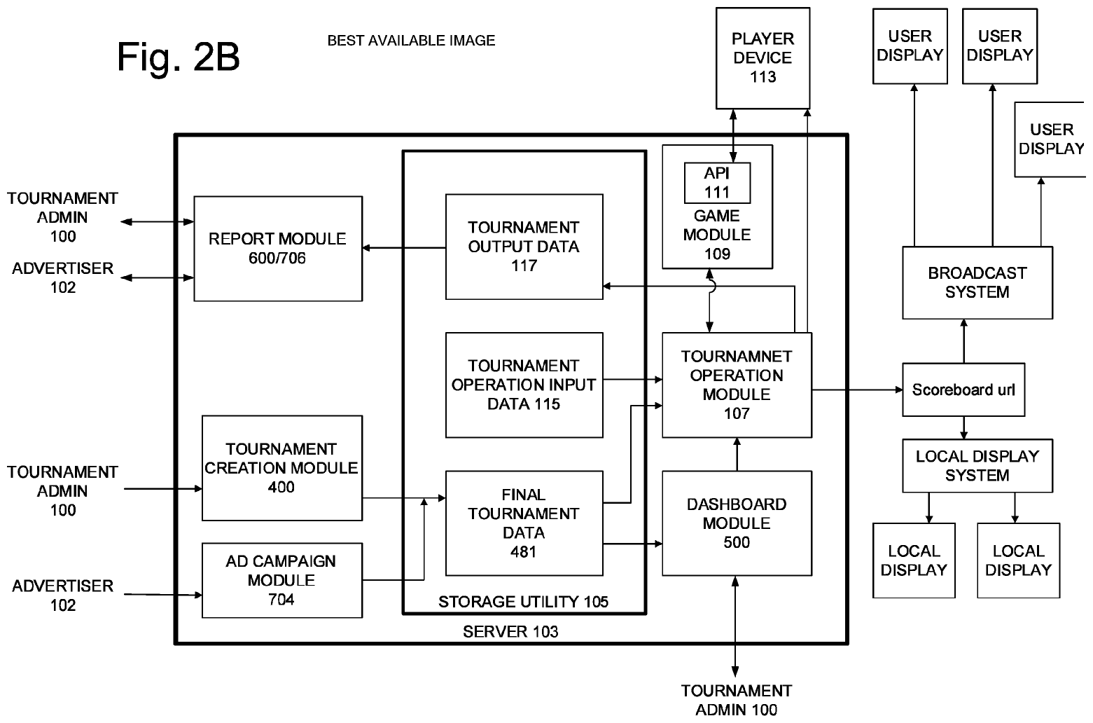

Reference is now made to FIG. 1A, which is a block diagram illustrating a system of the present invention for creating mobile gaming tournaments. The system includes a tournament administrator portal 200. The tournament administrator portal includes a tournament administrator verification/authentication module 300, a tournament creation tool/module 400, and a individual data report tool 602 and a global report tool 604. The verification/authentication module 300 is configured for authenticating the identity of the administrator 100 (via username and password, or any other available authentication method) and enabling a tournament administrator 100 (FIG. 2) to access the tools/modules of the portal 200. The individual report tool 602 is configured to access data relating to the past activity of the administrator 100 and generate one or more reports. A global reporting tool 604 is configured to generate reports based on data indicative of past activity of a plurality of tournament administrators and optionally of a plurality of advertisers. The tournament creation module 400 is configured for receiving inputs from the tournament administrator 100 and to create mobile gaming tournaments according to the inputs. A raw tournament database 401 is configured for storing unfinished data indicative of tournaments created via the tournament creation tool 400. A final tournament database 403 is configured for storing finished data indicative of tournaments created via the tournament creation tool 400.

In another variant, referring now to FIG. 1B, a block diagram illustrates a variant of the system of the present invention for creating mobile gaming tournaments. The system includes a tournament administrator portal 200 and optionally an advertiser's portal 700. The tournament administrator portal includes a tournament administrator verification/authentication module 300, a tournament creation tool/module 400, and a report module/tool 600. The verification/authentication module 300 is configured for authenticating the identity of the administrator 100 (via username and password, or any other available authentication method) and enabling a tournament administrator 100 (FIG. 2) to access the tools/modules of the portal 200. The tournament administrator is a representative of any entity that wishes to create a mobile gaming tournament. Non-limiting examples of such entities may include sports teams, arenas, stadiums, event organizers (concerts, conferences, etc.), venues (restaurants, bars, malls, cinema, etc.), radio stations, television stations, webcast stations, etc.

The tournament creation module 400 is configured for receiving inputs from the tournament administrator 100 and to create mobile gaming tournaments according to the inputs. A raw tournament database 401 is configured for storing unfinished data indicative of tournaments created via the tournament creation tool 400. A final tournament database 403 is configured for storing finished data indicative of tournaments created via the tournament creation tool 400.

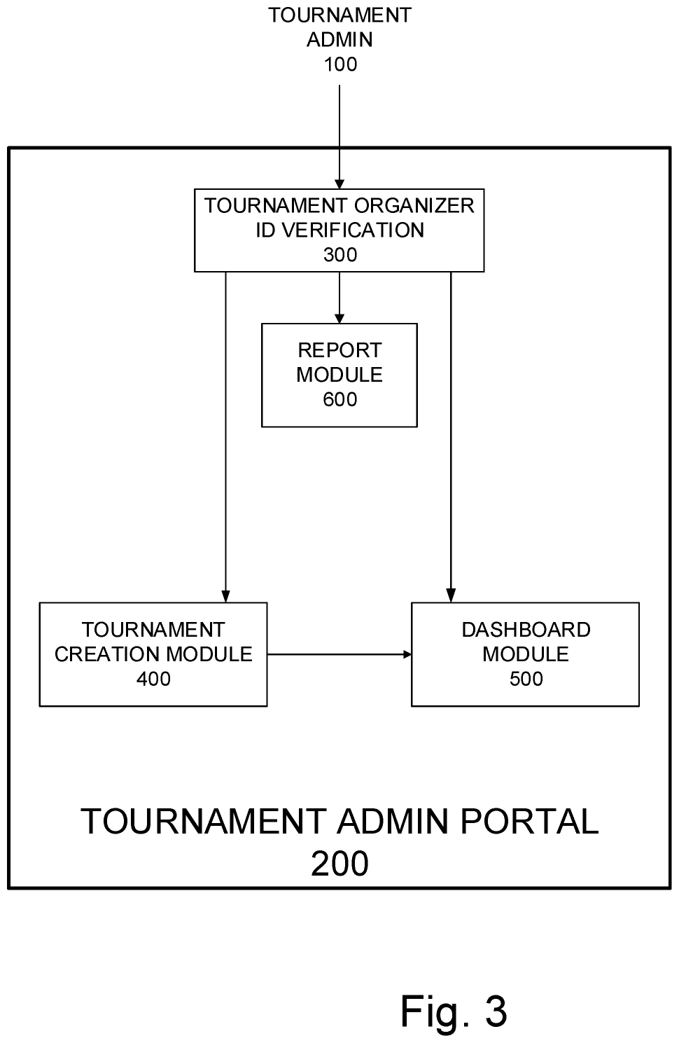

The report module 600 (see FIG. 3) may include an individual report tool 602 (FIGS. 1A, 1B), which is configured to access data relating to the past activity of the administrator 100 and generate one or more reports. Optionally, the report module 600 also includes a global reporting tool 604, which is configured to generate reports based on data indicative of past activity of a plurality of tournament administrators and optionally of a plurality of advertisers.

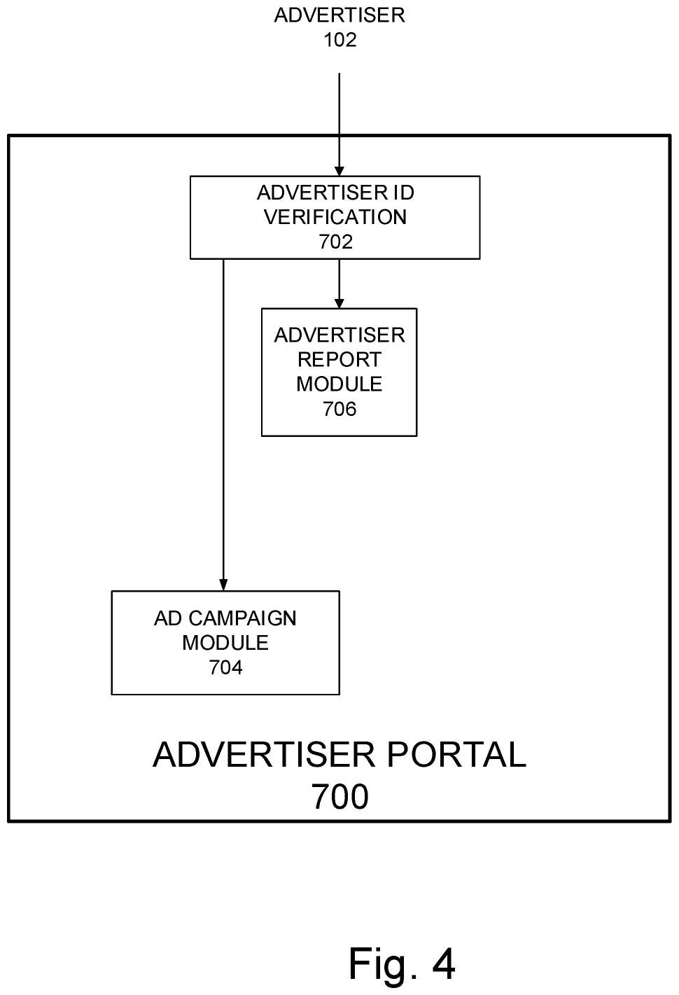

In some embodiments of the present invention, the system also includes an advertiser portal 700, which is configured for enabling advertisers to advertise services and/or products in tournaments created by tournament administrators. The advertiser portal includes an advertiser verification/authentication tool 702, an ad campaign tool 704, and optionally a report tool/module 706 (see FIG. 4).

The verification/authentication tool is configured for authenticating the identity of the advertiser 102 (via username and password, or any other available authentication method), and enabling the advertiser 102 to access the tools/modules of the advertiser portal 700. The ad campaign tool 704 enables an advertiser to view future tournaments created by tournament administrators, and advertise at or sponsor one or more future tournaments. The report tool/module 706 is configured for enabling reports to be generated and viewed by the advertiser. The reports may be global or specific to the respective advertiser.

In some embodiments of the present invention, the system includes a transaction module 707, which enables transfer of funds from an financial entity associated with the advertiser to a financial entity associated with the tournament administrator.

Reference is now made to FIG. 2A which is a block diagram of a system of the present invention implemented in a server 103. The server 103 is configured for running the different modules of the system of the present invention in a processing utility (not shown). The tournament administrator 100 uses the tournament creation module 400 to create one or more tournaments and yields final tournament data 481. The final tournament data 481 is stored in a storage utility 105 of the server. Instructions from the tournament administrator 100 are given to a tournament operation module 107. Tournaments may be started, ended, and run according to the tournament administrator's input and according to predetermined tournament operation input data 115. The tournament operation module outputs scoreboard screen data (e.g. XML files along with image files and/or movie files) indicative of static or dynamic images to static or dynamic URLs. Scoreboard screens are images, series of images, animated images, or movies configured for promoting the tournament and encouraging users to participate in the tournament. The scoreboard screen data contains information about player performance and ranking during and after tournament completion. The scoreboard screen data contains advertisements or sponsor trademarks. The URLs can be accessed by web browsers of local display systems to be broadcast to one or more local displays in one or more venues (e.g. larger screens in stadiums or arenas, or screens in a mall, cinemas, etc.). Optionally or alternatively, the URLs may be accessed by broadcast systems (such as television or web broadcasting systems) connected to a plurality of user displays (TV sets, desktop computers, laptop computers, tablet computers, handheld communication devices, smartphones, etc.). The graphics of the URL may be displayed as on overlay to the broadcasts. The tournament operation module 107 also interacts with a game module 109 associated with an API 111. The game module is accessible to the player via a player device 113 which has a web browser that accesses a URL associated with the game module. It should be noted that the game module may be any third party game module. The API 111 allows for communication between the game module and the tournament operation module. Optionally, at least one parameter in the game module is dependent on the final tournament data. The parameter may, for example, include a game mode, or graphics to be inserted in the game screen (e.g. banners, movies, etc).

The API 111 communicates a player's score to the tournament operation module 107, enabling the tournament operation module 107 to determine a winner from a plurality of players according to the tournament operation input data 115. Optionally, the player device is connected to the game module via a player identifier (e.g. username and password, or third-party login, such as Facebook, Google+, or any other). Optionally, the API is configured for receiving player information associated with the player identifier (e.g. email address, location, etc.). If the player information includes the user's contact information (e.g., email address or phone number), the tournament creation module 107 may be configured for automatically sending a message to the player via the known contact information, in order to inform the player that the player has won and to instruct the player on how to claim the prize. The prize may be a real prize or may include an electronic coupon redeemable for a real prize. The details on the graphics and text of the electronic coupon are input in the tournament creation module and/or ad campaign module, and are included in the final tournament data 481.

In another variant, referring to FIG. 2B, a block diagram of a variant of the system of the present invention is implemented in a server 103. The server 103 is configured for running the different modules of the system of the present invention in a processing utility (not shown). The tournament administrator 100 uses the tournament creation module 400 to create one or more tournaments and yields tournament data. The tournament data may be in final form (final tournament data 481) or may be edited by the advertiser 102 via the ad campaign module 704 to be converted to final tournament data 481.

The final tournament data 481 is stored in a storage utility 105 of the server, and is retrieved by a dashboard module 500 to create a dashboard/control panel configured for enabling the tournament administrator 100 or an agent thereof to control an operation of the tournaments, as will be explained further below.

Via the dashboard/control panel, the tournament administrator can initiate a tournament created previously. Instructions from the tournament administrator 100 are given to a tournament operation module 107. Tournaments may be started, ended, and run according to the tournament administrator's input and according to predetermined tournament operation input data 115. The tournament operation module outputs scoreboard screen data (e.g. XML files along with image files and/or movie files) indicative of static or dynamic images to static or dynamic URLs. Scoreboard screens are images, series of images, animated images, or movies configured for promoting the tournament and encouraging users to participate in the tournament. The scoreboard screen data contains information about player performance and ranking during and after tournament completion. The scoreboard screen data contains advertisements or sponsor trademarks. The URLs can be accessed by web browsers of local display systems to be broadcast to one or more local displays in one or more venues (e.g. larger screens in stadiums or arenas, or screens in a mall, cinemas, etc.). Optionally or alternatively, the URLs may be accessed by central broadcasting systems (such as television or web broadcasting systems) connected to a plurality of user displays (TV sets, desktop computers, laptop computers, tablet computers, handheld communication devices, smartphones, etc.). The graphics of the URL may be displayed as on overlay to the broadcasts.

The tournament operation module 107 also interacts with a game module 109 associated with an API 111. The game module is accessible to the player via a player device 113 which has a web browser that accesses a URL associated with the game module. It should be noted that the game module may be any third party game module. The API 111 allows for communication between the game module and the tournament operation module. Optionally, at least one parameter in the game module is dependent on the final tournament data. The parameter may, for example, include a game mode, or graphics to be inserted in the game screen (e.g. banners, movies, etc).

The API 111 communicates a player's score to the tournament operation module 107, enabling the tournament operation module 107 to determine a winner from a plurality of players according to the tournament operation input data 115. Optionally, the player device is connected to the game module via a player identifier (e.g. username and password, or third-party login, such as Facebook, Google+, or any other). Optionally, the API is configured for receiving player information associated with the player identifier (e.g. email address, location, etc.). If the player information includes the user's contact information (e.g., email address or phone number), the tournament creation module 107 may be configured for automatically sending a message to the player via the known contact information, in order to inform the player that the player has won and to instruct the player on how to claim the prize. The prize may be a real prize or may include an electronic coupon redeemable for a real prize. The details on the graphics and text of the electronic coupon are input in the tournament creation module and/or ad campaign module, and are included in the final tournament data 481.

Optionally, the tournament operation module 107 is configured for collecting tournament output data 117, which may include one or more parameters such as player identification, player contact information, general player information (name, sex, age, if available), number of turns played by the player, length of time played by each player, etc. Optionally the tournament output data 117 is stored in the storage utility 115 and is accessible to the tournament administrator 100 and/or advertiser 102 via respective report modules 600 and 706.

FIG. 3 is a block diagram illustrating the tournament administrator portal 200. The tournament administrator portal 200 includes a verification/authentication module 300 and a tournament creation module 400. Optionally a dashboard module 500 and/or a report module 600 are included in the tournament administration portal. It should be noted that the data that is viewable to the tournament administrator via the report module 600 is limited to each administrator according to a predetermined agreement between the entity represented by the tournament administrator and the entity operating the tournament administrator portal. Optionally, functionalities of the tournament creation module and/or dashboard module available to the tournament administrator may be limited according to said predetermined agreement.

FIG. 4 is a block diagram illustrating the advertiser portal 700. The advertiser portal 700 includes a verification/authentication module 702, an ad campaign module 704, and optionally an advertiser report module 704. It should be noted that the data that is viewable to the advertiser via the report module 706 is limited to advertiser according to a predetermined agreement between the entity represented by the advertiser and the entity operating the advertiser portal. Optionally, functionalities of the ad campaign available to the advertiser may be limited according to said predetermined agreement.

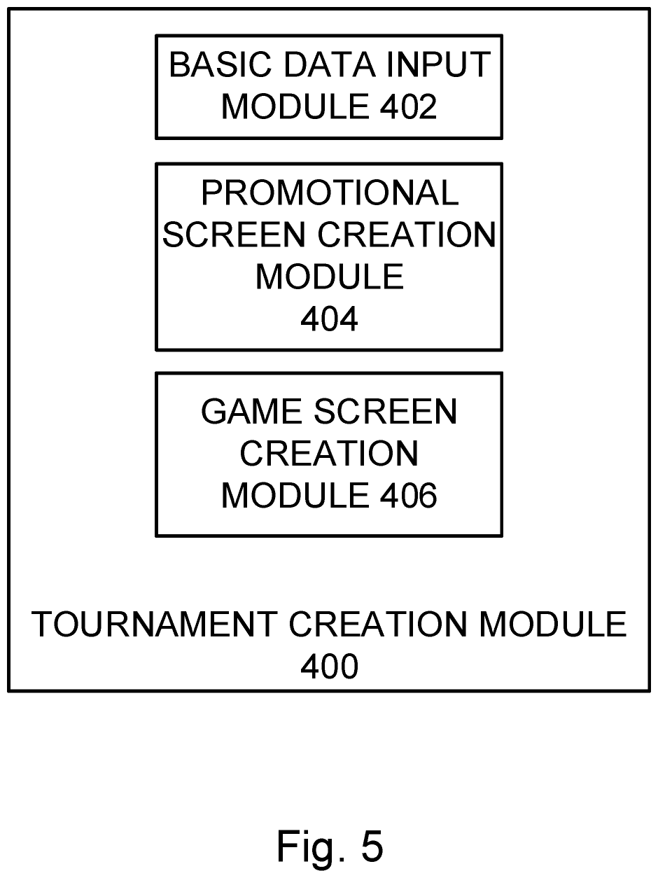

FIG. 5 is a block diagram illustrating details about the tournament creation module. In some embodiments of the present invention, the tournament creation module 400 includes a basic data input module 402, and optionally a scoreboard creation module 404 and/or a game screen creation tool 406.

The game screen creation module 406 is similar to the promotion screen creation module 404. The game screen creation module 406 may or may not have a resolution tool, as it is based on game's screen resolution.

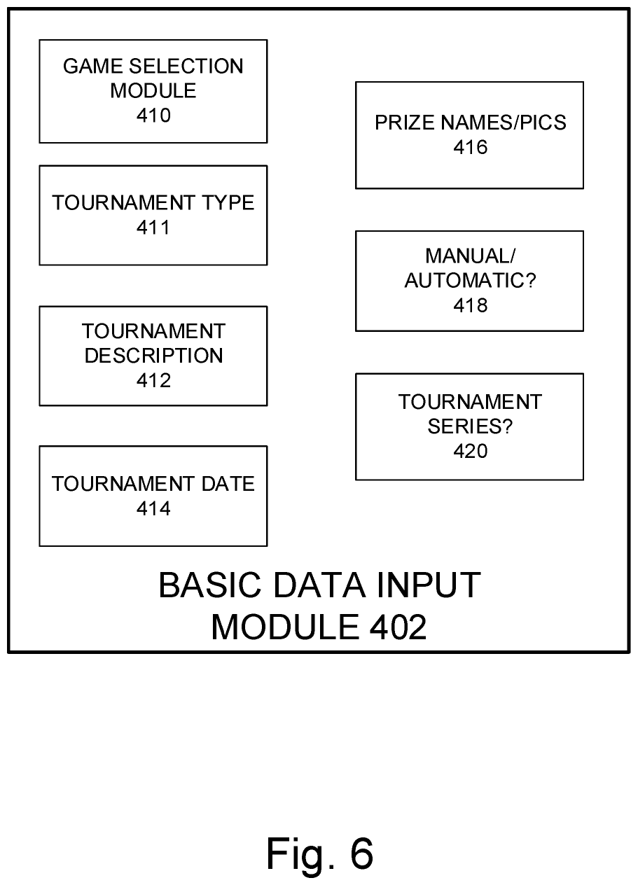

An example of the basic data input module 402 is illustrated in FIG. 6. The basic data input module 402 is configured for enabling the tournament administrator to create a tournament and input data required for tournament creation.

The basic data input module includes a game selection module 410, a tournament type module 411, a tournament description module 412 (optional), a tournament date module 414, a prize module 416, an automation module 418, and a series module 420.

The game selection module 410 provides the tournament administrator with options to select a game from a predetermined game library, and then the selected game is used by the system in a tournament. The game may be any mobile game or tool. The game may be provided by a third party and integrated into the system of the present invention with an API, as explained above.

The tournament type module 411 is configured to provide the tournament administrator with options to select a type of created tournament. Tournament types may include, for example, tournament for venue, tournament for webcast, tournament for television broadcast, tournament for social media, etc. The tournament type parameter is advantageous, as different tournament types planned for the same date may be controlled by different administrators belonging to the same entity. Thus, different dashboards for different tournament types are created, for enabling each administrator to operate his/her respective tournaments. Different types may be assigned to a single tournament. In such a case, a rule may be input to determine a priori which of the administrators has control over the common tournament(s).

The tournament description module 412 is configured for allowing the tournament administrator to add descriptive text and associate it with each tournament.

The tournament date module 414 is configured to receive a date from the tournament administrator, and this date is used by the system to determine when the tournament is conducted. Tournaments having the same date and same type are placed under the same dashboard.

The prize module 416 enables the tournament administrator to input names and optionally images of custom prizes for tournaments.

The automation module 418 is a toggle and controls whether the tournament being created is started (and optionally stopped) manually or automatically. Certain venues, such as sports teams, will prefer the tournaments to be manually operated, so a tournament administrator or an agent thereof can initiate and end tournaments according to the specific necessities of the event occurring at the time of the tournament. For example, if the event is a basketball game, and the tournament is supposed to start at halftime, a tournament organizer or agent thereof can follow the basketball game and start the game in real-time exactly at half time. In some embodiments, the automation module enables the choice of the tournament's length a priori. For example, a tournament will end automatically a certain time after it has been manually initiated. In other embodiments, the automation module requires ending a tournament manually in real-time.

The series module 420 is a control for whether the tournament a single tournament or part of a series. In a single tournament, the winners of the tournament are given a prize at the end of the tournament. In a tournament series, points are awarded to players at each tournament of the series. At the end of the series' last tournament, the player with the least or most points (depending on the rules of the tournament) is declared winner and is eligible to receive prize.

Optionally, if many single tournaments occur around the same time period (e.g. in the same day, or surrounding a single event), a rule can be input to preclude winners of single tournaments held in the same the period to be declared winners of following tournaments held in the same time period.

Once a tournament has been created, it can be saved as a template for later use.

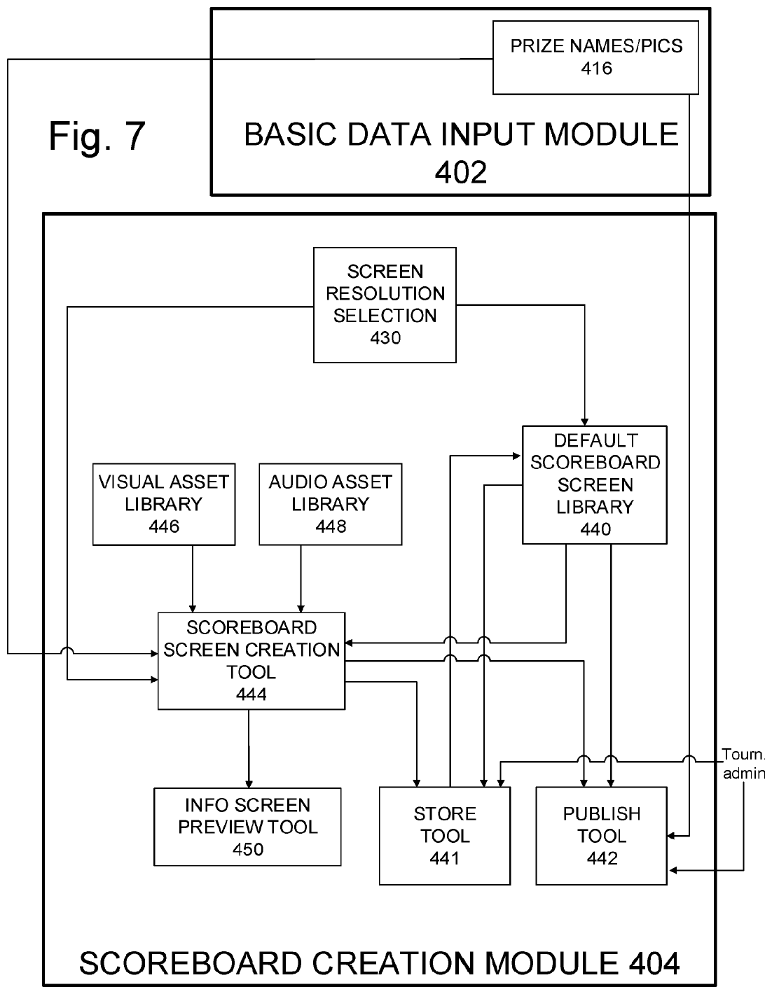

FIG. 7 is a block diagram illustrating the scoreboard creation module 404, according to some embodiments of the present invention. As mentioned above, scoreboard screens may include one or more static images, animated images, series of images, movies, and/or series of movies, configured for being displayed to players to encourage players to participate in the tournament.

Different entities (tournament administrators) may desire to have respective customized screens. In some embodiments of the present invention, data relating to the scoreboard screens may be externally created and input by the tournament administrator into the store tool 441 and publish tool 442. The store tool allows one or more scoreboard screens to be stored in the default scoreboard info screen library 440 for future use. The publish tool 442 is configured for outputting data (e.g. one or more XML files) and embedding such data in a URL created for viewing the created scoreboard screen(s).

Optionally, a scoreboard screen creation tool 444 is configured for enabling the tournament administrator to create one or more screens based on default screens from the default library/database 400, visual asset library 446, and audio asset library 448. In some embodiments of the present invention, the tournament administrator is able to upload assets into the visual asset library and audio asset library. Visual assets are images or video and audio assets are recorded sounds. Optionally, a preview tool 450 is configured for receiving data from the creation tool 444 to show a preview of the scoreboard screen(s).

Optionally, different scoreboard screens or series of scoreboard screens can be designated differently, so the display of each can be controlled individually (as will be explained below).

In some embodiments of the present invention, before creating the scoreboard screens, a resolution selection tool 430 enables the tournament administrator to choose a desired resolution matching the resolution of the displays upon which the scoreboard screen(s) is (are) to be displayed.

Optionally, the data indicative of prize pictures can be extracted by the publish tool 442 and preview tool 450, to display the prizes 497 for the specific tournaments. Each scoreboard (FIGS. 10 and 11) for a tournament is configurable by system, via inputs provided to the system.

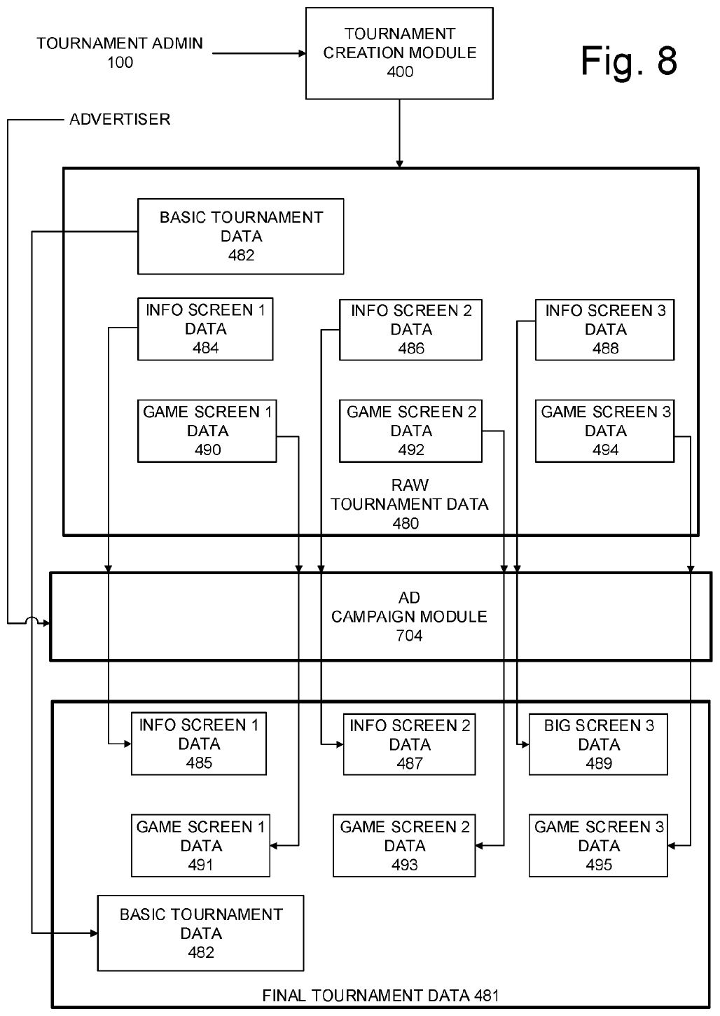

FIG. 8 is block diagram illustrating output from the promotion screen creation module for a tournament. The output of the tournament creation module 400 is raw tournament data 480 or final tournament data 481. In some embodiments of the present invention, the tournament administrator can decide whether the promotion screens output by the promotion screens creation module and the game screens output by the game screen creation module are final, or whether they can be modified by an advertiser. If the screens are final, they are saved as final scoreboard screens 485, 487, 489, and final game screens 491, 493, and 495. If they can be modified, they are saved as raw scoreboard screens 484, 486, 488, and raw game screens 490, 492, and 494.

The advertiser can access the raw screens via the ad campaign module 704 and apply changes to them. If such changes are acceptable to the tournament administrator, the raw screens are converted to final screens.

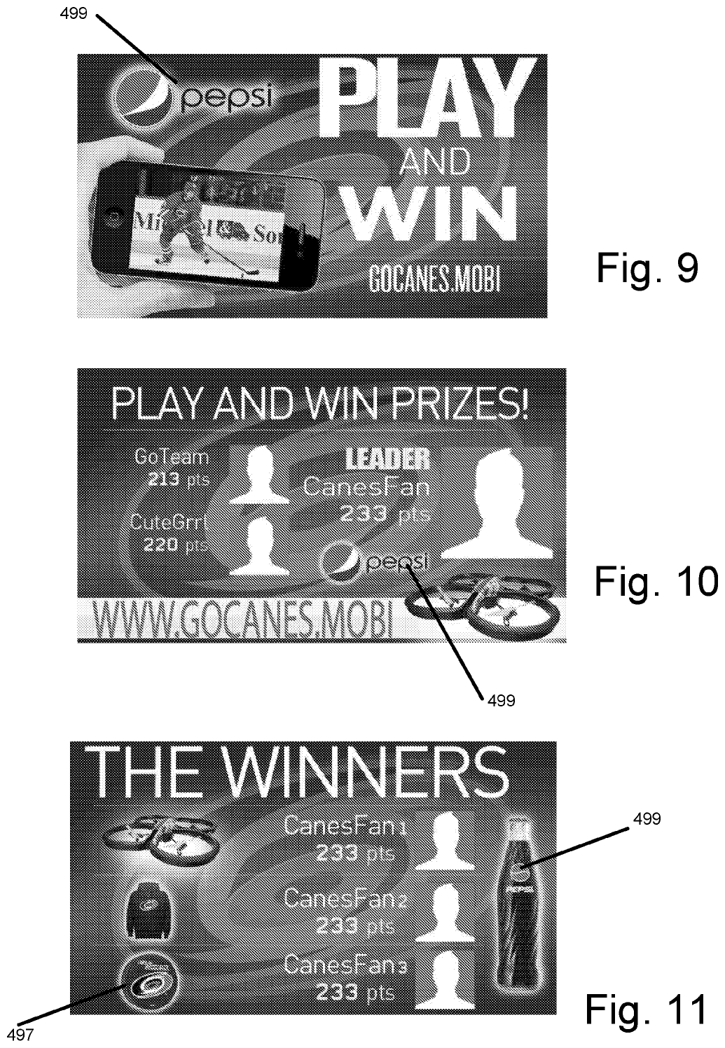

FIGS. 9-14 are screen views of final scoreboard screens with ads 499. Optionally, when the raw scoreboard screens are created, a space for advertisements is created as well. Each space for advertisements has a specific size chosen by the tournament administrator. The specific sizes are published so the advertiser can create ad images that match the specific sizes.

FIG. 10 illustrates displaying the names, pictures and profiles of players of the tournament, while the tournament is taking place. FIG. 11 illustrates displaying the top performers of the tournaments, after the tournament has been completed.

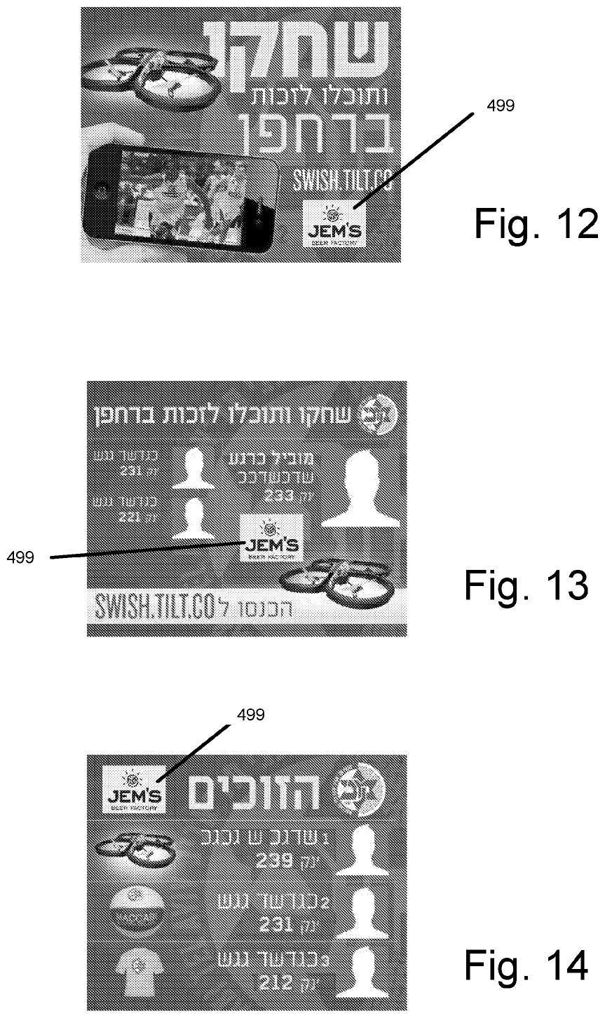

It should be noted that the screens exemplified in FIGS. 9-11 are part of a series of screens that are displayed on after the other at predetermined times at the URL discussed in FIG. 1. The screens of FIGS. 12-14 are also part of a second series of screens. The screens of FIGS. 9-11 have a first resolution and/or aspect ratio (e.g. 920×540 pixels), while the screens of FIGS. 12-14 have a second resolution and/or aspect ratio (e.g. 720×576 pixels). Both sets of screens can be accessed via the URL, by typing respective parameters after the URL address.

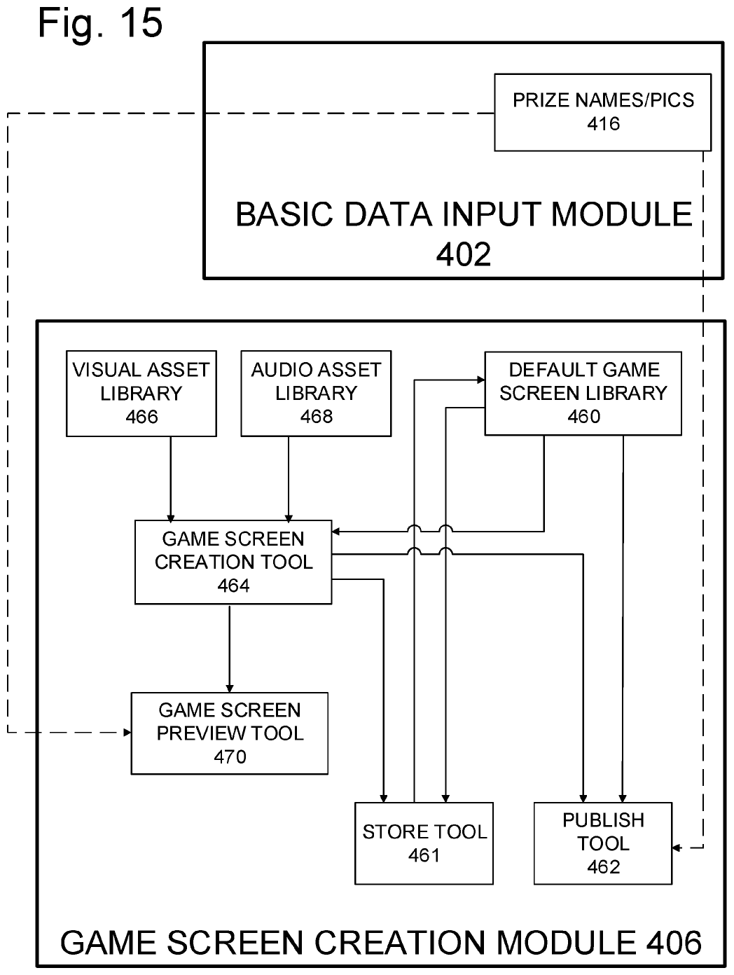

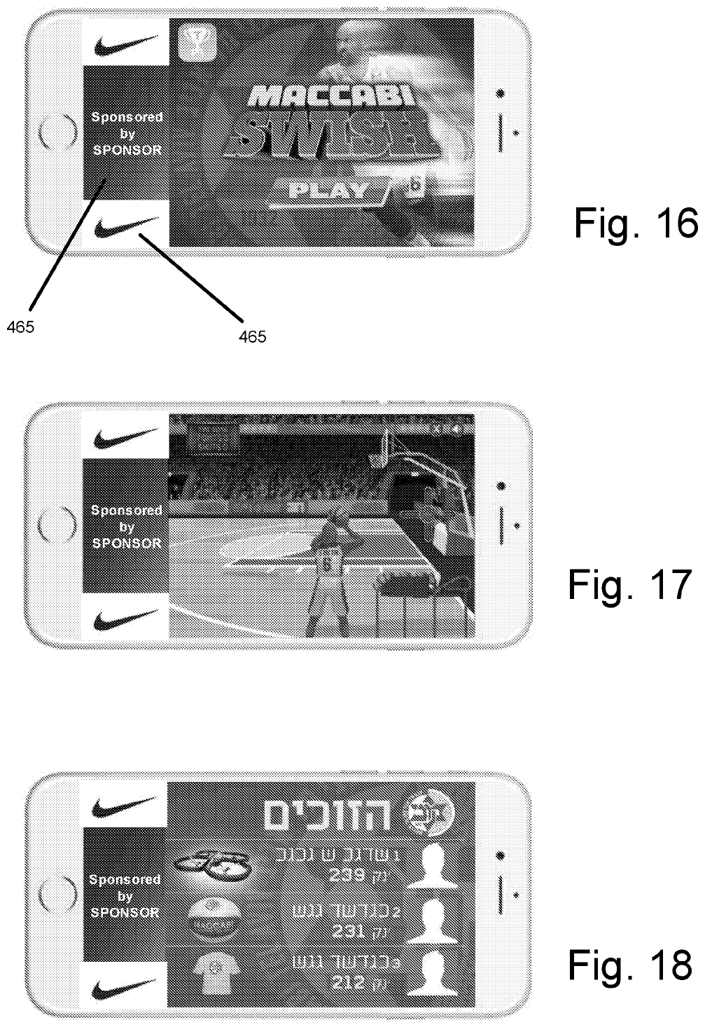

FIG. 15 is block diagram illustrating the game screen creation module, according to some embodiments of the present invention. The game screen creation module 406 is similar to the scoreboard creation module 404. Instead of creating scoreboard screens, the game screen creation module allows the tournament administrator to designate areas within different screens of a mobile game as advertisement areas. These advertisement areas have specific sizes that are published for the advertisements. FIGS. 16-18 show different screens of a game in which sponsor images 465 are inserted. The sponsor images may be static images or movies. Optionally, the player may be limited to play a first number of turns. If the player wishes to play more turns than the first number of turns, the system may prompt the player to perform an action (for example, view a movie, access a website, download an app, etc.) in order to get access to more turns.

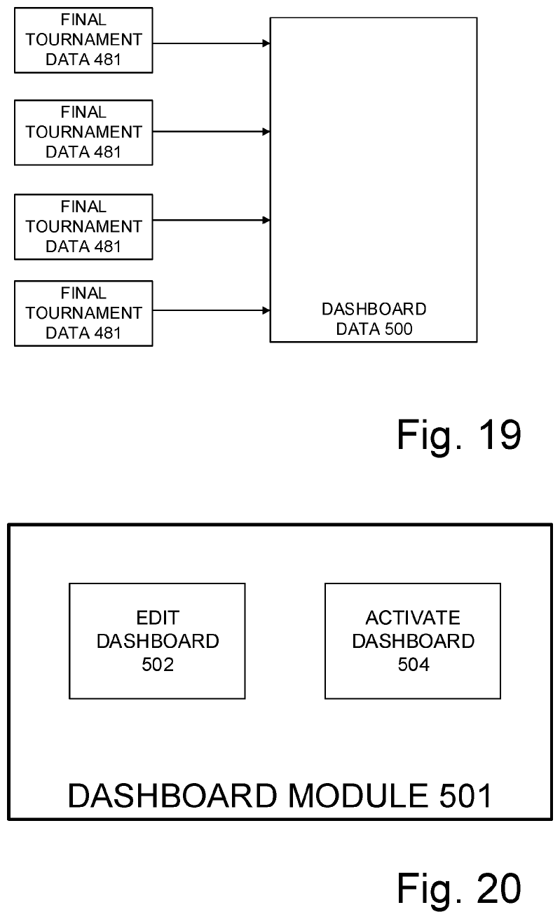

FIG. 19 is a block diagram illustrating the creation of a dashboard, according to some embodiments of the present invention. Final data 481 from each tournament created by a certain administrator for a chosen time or time interval is used to create dashboard data 500.

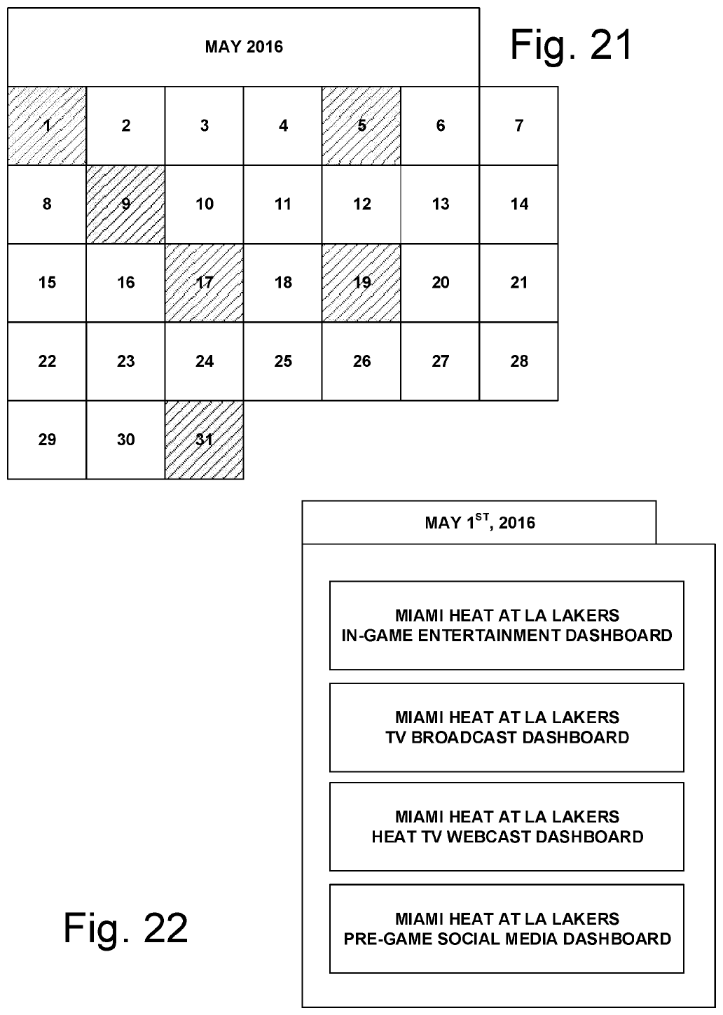

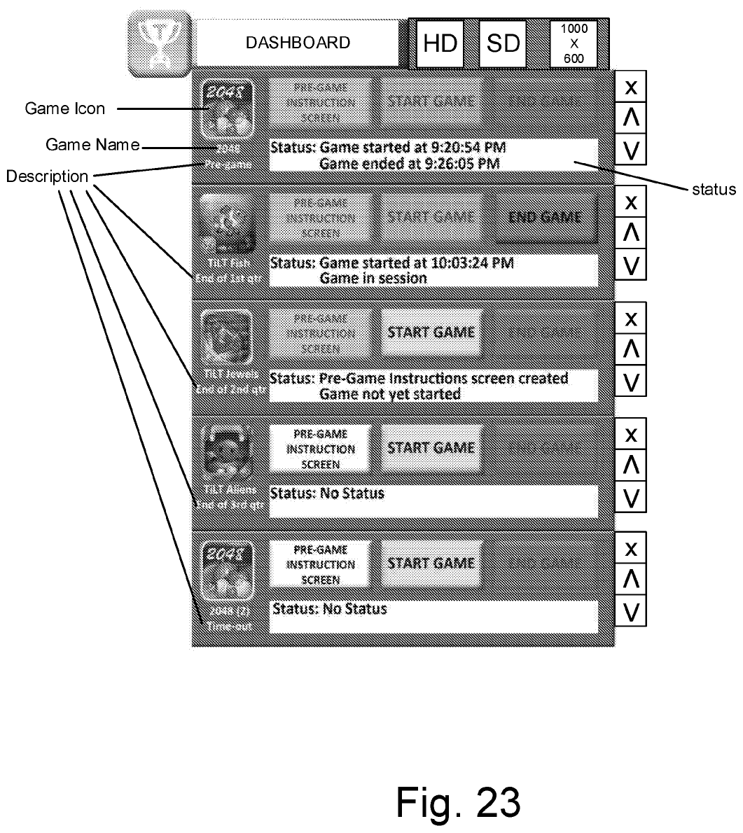

FIG. 20 is a block diagram illustrating a dashboard module 501 of the present invention. The dashboard module 501 includes an edit tool 502 and an activate module 504. The edit module 502 opens a calendar screen (FIG. 21) in which dates for which a dashboard has been created are shown (e.g., May 1^{st}, 5^{th}, 9^{th}, etc.). Once the specific date is selected, a screen showing different dashboards for the same date is opened (FIG. 22). Once a specific dashboard is selected, a graphical representation of the dashboard is shown (FIG. 23).

Editing the dashboard may include one or more of changing description, changing the order of the games, choosing the resolution (SD, SD, 1000×600, for example) of the scoreboard screens.

Activating the dashboard via the activate tool 504 (FIG. 20) allows one or more of the following: opening a browser page of the URL showing pre-game scoreboard screens, starting the tournament and opening a browser page of the URL showing in-game scoreboard screens, ending the tournament and activating the URL of the in-game scoreboard screens to show a final leaderboard of the tournament.

Optionally, as different tournaments are activated and deactivated, the status window is updated.

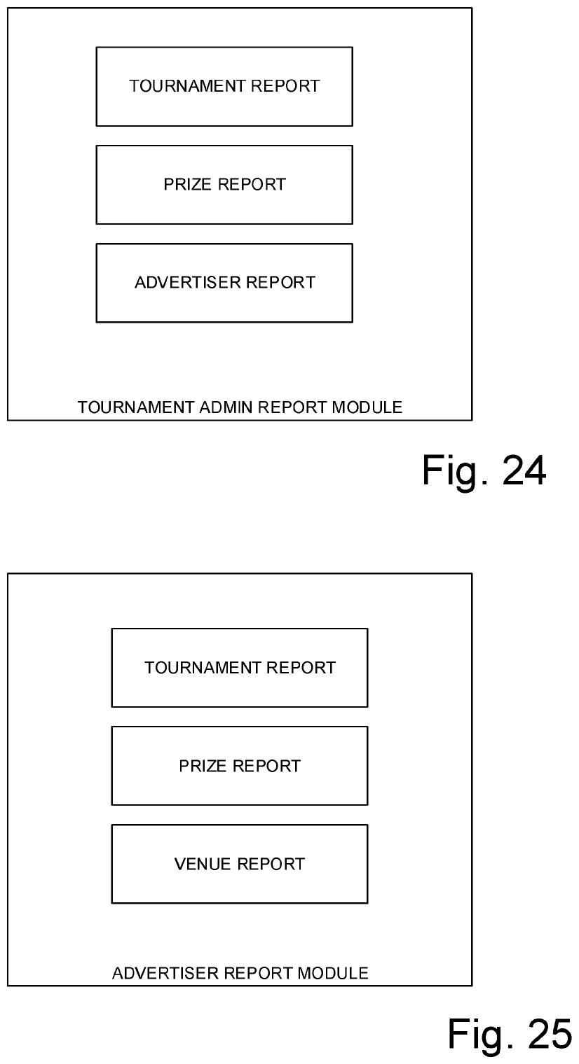

FIGS. 24-29 relate to reports for keeping track of data of interest. The data listed below is a non-limiting example. Additional data may also be included in the reports.

FIGS. 24 and 25 show respectively a tournament administrator report module and an advertiser report module. Both modules include a tournament report tool and a prize report tool. The tournament admin report module includes an advertiser report tool. The advertiser report module includes a venue report tool.

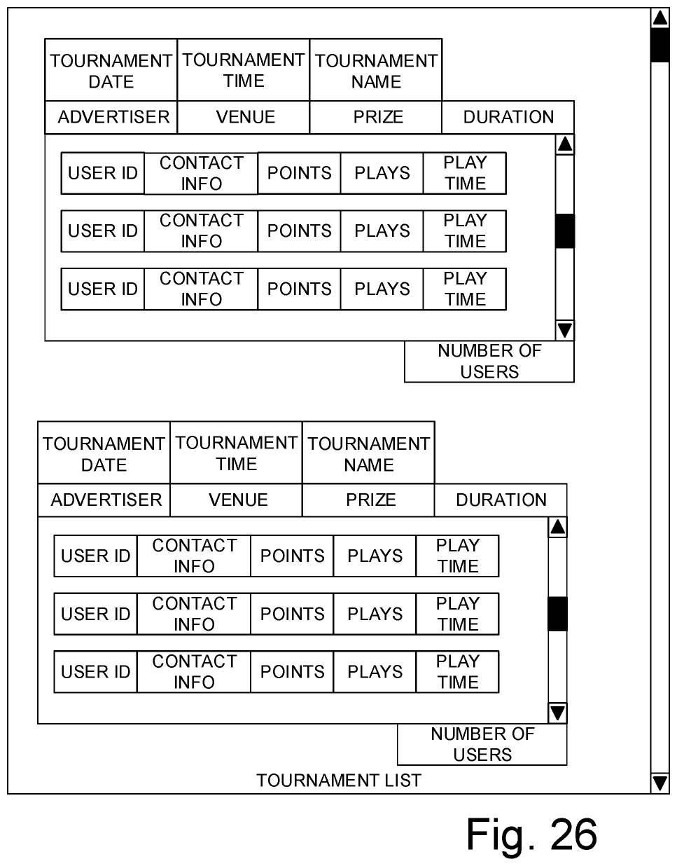

FIG. 26 shows a tournament report, in which each tournament is associated with a respective window. The tournament window includes information relating to the tournament date, time, name, duration, advertiser, venue, and prize. Optionally, the number of users and details about such users are also included.

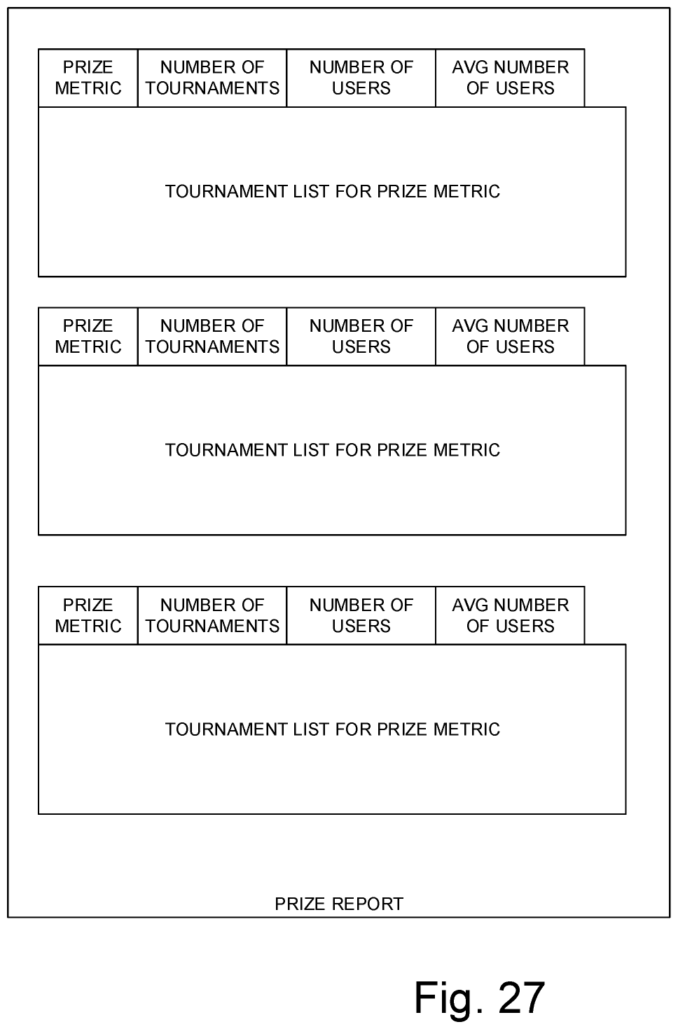

In the prize report (FIG. 27), the report may list separate sections for each type prize metric, and the prize metric could be a monetary value, or a category of the prize (such as a toy or an appliance or electronic etc.) and each prize metric is associated with a respective section or window. Optionally, for each prize metric, the tournaments at which the prize corresponding to the metric was awarded are listed. Alternatively or additionally, the number of tournaments at which the prize having a certain prize metric was awarded is shown, along with the total number of users and the average number of users per tournament.

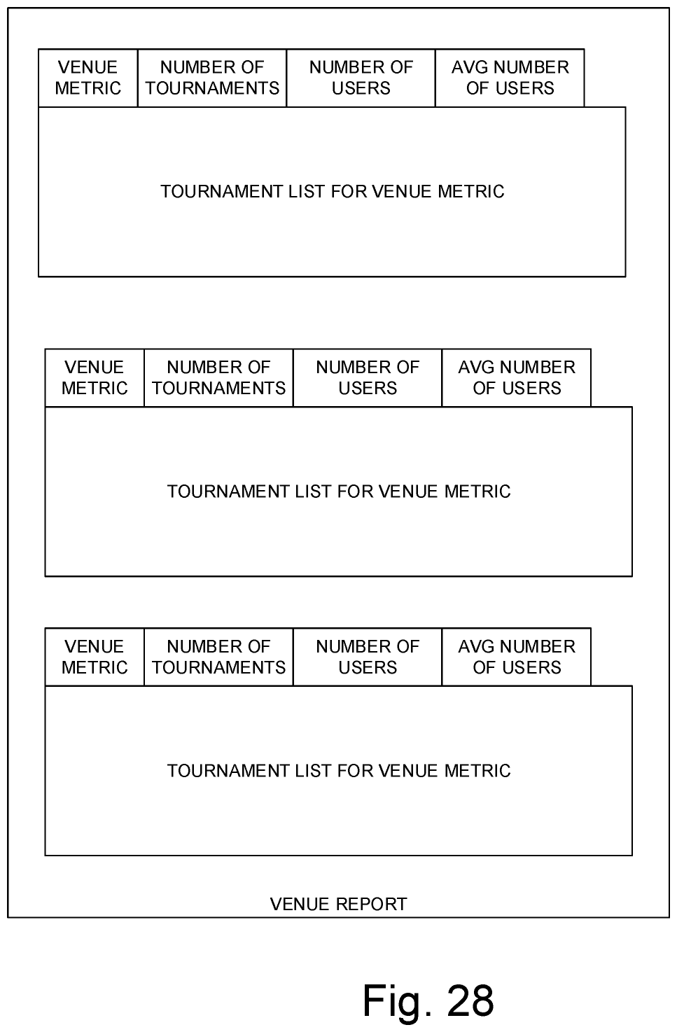

In the venue report (FIG. 28), each venue metric is associated with a respective section of the screen or window. A venue may comprise, for example, the seating capacity, the type of venue, (e.g. closed arena, open stadium, outdoor field, concert hall, etc.) Optionally, for each venue metric, the tournaments held at venues sharing the same metric are listed with the associated individual data values, such as number of players who competed, what prizes were awarded, etc. Alternatively or additionally, the number of tournaments held at the venue is shown, along with the total number of users and the average number of users per tournament.

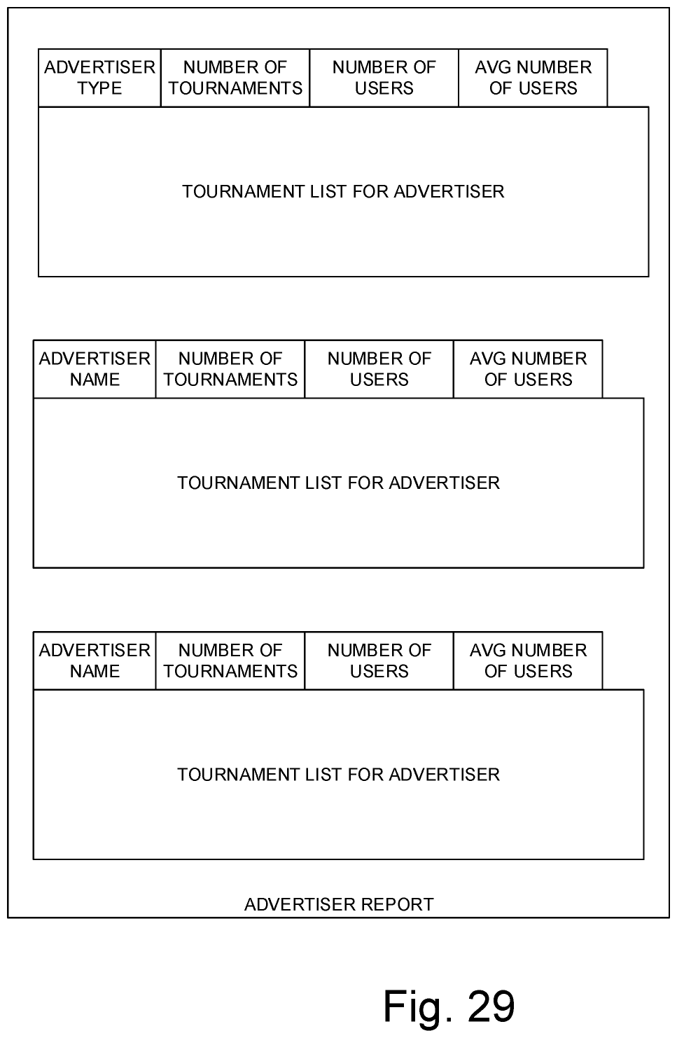

In the advertiser report (FIG. 29), each advertiser is associated with a respective window. Optionally, for each advertiser, the tournaments sponsored by the advertiser listed. Alternatively or additionally, the number of tournaments sponsored by the advertiser is shown, along with the total number of users and the average number of users per tournament.

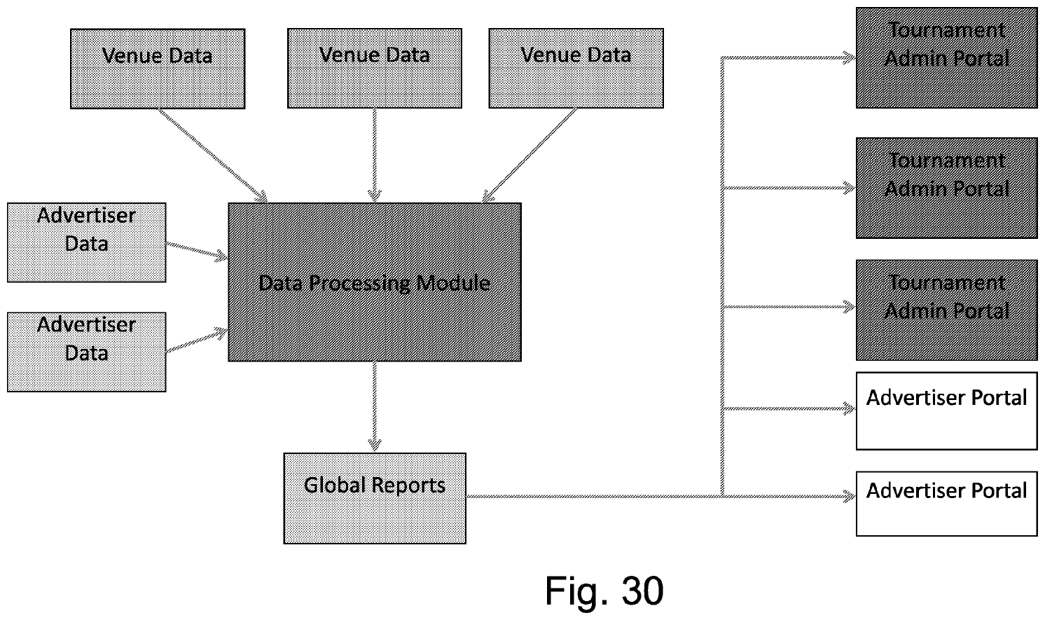

FIG. 30 is a block diagram showing the processing of data from different advertisers/venues to create global data reports that can be provided to all tournament administrators and advertisers.

Some data generated at tournaments held by/for different venues and advertisers is processed in a data processing module to yield global reports. Such global reports can be viewed by some or all tournament administrators and/or advertisers.

In a variant, a customized scoreboard is generated for each computerized game tournament conducted. A system with a processor and a memory having instructions stored thereon, containing any of the variants of the herein described methods, may be constructed.

In another variant, a computer implemented method comprises: displaying an input interface that prompts a user for tournament data; receiving tournament data; displaying an input interface that prompts the user for scoreboard data; receiving scoreboard data; operating a computerized game tournament according to the tournament data; generating a customized tournament scoreboard, customized for the tournament being operated, according to the scoreboard data and data generated by the operation of the tournament; and displaying player information on the customized tournament scoreboard.

In a further variant, the method further comprises generating a URL to point to the customized tournament scoreboard; and accessing the URL which causes the displaying of the customized tournament scoreboard on a local display system and/or a broadcast system.

In still another variant of the method, the player information comprises an image associated with the player, and a name associated with the player and a score achieved by the player in the operated tournament.

In yet a further variant of the method, the scoreboard data comprises at least one of a background image, prize image and sponsor image. The scoreboard data may optionally comprise an audio track.

In a variant, a computer implemented method comprises: displaying a first input interface that prompts a first user for tournament data; receiving tournament data; displaying a second input interface that prompts the first user for scoreboard data; receiving scoreboard data from the first user; displaying a third input interface that prompts a second user to input additional scoreboard data; receiving the scoreboard data and the additional scoreboard data;

operating a computerized game tournament according to the tournament data; generating a customized tournament scoreboard, customized for the tournament being operated, according to the scoreboard data and to the additional scoreboard and according to the data generated by the operation of the tournament; displaying player information on the customized tournament scoreboard.

In another variant, the method comprises generating a URL to point to the customized tournament scoreboard and accessing the URL which causes the displaying of the customized tournament scoreboard on a local display system and/or a broadcast system.

In a further variant, a computer implemented method comprises: operating an electronic tournament generator configured to receive tournament data. Tournament data may comprise, for example, prizes, venues, dates, in game, social media, mass media tournament, sponsor. The method comprises: characterizing some of the tournament data according to one or more metrics; operating a plurality of computer based game tournaments; receiving output data about players participating in the tournaments; storing the data into a database; prompting the user to select a metric; organizing the data according to a selected one of the metrics based on the data stored in the database; and generating a report that matches the selected metric to the output data metrics to the output data generated from the tournaments. Characterized according to one or more metrics, may for example, be assigning a monetary value to a prize.

In some cases, either the tournament generator or a third party that has access to the data, characterizes some of the data according to certain metrics. If a sports team has a tournament, and the persons who created the tournament do not properly characterize the prizes, a third party, for example, an employee of the system, may input the metric.

In still another variant of the method, the tournament data comprises one or more of: venue, prize, sponsor name and tournament type. Tournament type may be defined by where the tournament is made known or advertised to the public. For example, during a sporting event at the event, on a social media, a TV broadcast, the Internet.

In yet a further variant of the method, receiving output data comprises receiving the numbers of males and female players who played in the tournament, and the geographical locations of the players.

In a further variant, generating the report comprises returning counts for individual metrics to a user.

In another variant, the output data comprises any one or more of: number of players, scores, ranks, names/IDs, ages, profiles, sex, geographic location.

In a variant, the one or more metrics comprise any one or more of: type of prize, monetary value of the prize, venue's seating capacity, location of the venue, time of day of tournament, sponsor's industry type.

In yet a further variant, the method further comprises a plurality of users operating the tournament generator to generate a plurality of tournaments unique to each user, wherein the output data for each tournament is assessable to the respective user operating the specific tournament. Operating the tournament could be, for example, setting it up, being the owner and advertising the tournament. Tournament data metrics are combined and the output data from the tournaments generated by the users, and a global report is generated and accessible to the users and containing the combined tournament data metrics and output data.

In still another variant, the metrics in the global report include one or more of: venue metric, prize metric, tournament type and sponsor metric.

In one example, global data does not contain individual tournament data, but only general metrics. For example, sponsor name and venue name are not included, but global data does include venue type, seating capacity, prize metric, tournament type.

Venue, prize, sponsor tournament type are examples, and any descriptor can be used in the report, that can have data generated thereabout. A tournament creator wants to find out how its audience reacts to different characteristics of the tournament. This data provides information that lets him know which features, work best at getting the most response, players, participation, etc.

In a variant, a system for generating electronic game tournaments comprises a processor and a memory having instructions stored thereon that when executed cause the processor to generate: an input interface that prompts a user for tournament data; an input interface that prompts the user for scoreboard data; a computerized game tournament according to the tournament data; a customized tournament scoreboard, customized for a tournament being operated, according to scoreboard data and data generated by the operation of the tournament; and a display of player information on the customized tournament scoreboard.

In another variant, a system for generating a report of metrics from electronic game tournaments comprises a processor and a memory having instructions stored thereon that when executed cause the processor to generate: an electronic tournament generator configured to receive tournament data and characterizations of some of the tournament data according to one or more metrics; a plurality of computer based game tournaments; output data about players participating in the tournaments; a database of the tournament data and output data; a prompt for a user to select a metric; an organized version of the data according to a selected one of the metrics based on the data stored in the database; and a report that matches the selected metric to the output data metrics to the output data generated from the tournaments.

What is claimed is:

1. A computer implemented method, comprising:
displaying an input interface that prompts a user for tournament data;
receiving tournament data;
displaying an input interface that prompts the user for scoreboard data;
receiving scoreboard data;
operating a computerized game tournament according to the tournament data;
generating a customized tournament scoreboard, customized for the tournament being operated, according to the scoreboard data and data generated by the operation of the tournament;
displaying player information on the customized tournament scoreboard.

2. The method of claim 1, further comprising, generating a URL to point to the customized tournament scoreboard; and accessing the URL which causes the displaying of the customized tournament scoreboard on a local display system and/or a broadcast system.

3. The method of claim 2, herein the player information comprises an image associated with the player, and a name associated with the player and a score achieved by the player in the operated tournament.

4. The method of claim 2, wherein the scoreboard data comprises at least one of a background image, prize image and sponsor image.

5. The method of claim 2, wherein the scoreboard data comprises an audio track.

6. A computer implemented method, comprising:
displaying a first input interface that prompts a first user for tournament data;
receiving tournament data;
displaying a second input interface that prompts the first user for scoreboard data;
receiving scoreboard data from the first user;
displaying a third input interface that prompts a second user to input additional scoreboard data;
receiving the scoreboard data and the additional scoreboard data;
operating a computerized game tournament according to the tournament data;
generating a customized tournament scoreboard, customized for the tournament being operated, according to the scoreboard data and to the additional scoreboard and according to the data generated by the operation of the tournament;
displaying player information on the customized tournament scoreboard.

7. The method of claim 6, further comprising, generating a URL to point to the customized tournament scoreboard; and accessing the URL which causes the displaying of the customized tournament scoreboard on a local display system and/or a broadcast system.

8. A computer implemented method comprising:
operating an electronic tournament generator configured to receive tournament data;
characterizing some of the tournament data according to one or more metrics;
operating a plurality of computer based game tournaments;
receiving output data about players participating in the tournaments;
storing the data into a database;
prompting the user to select a metric;
organizing the data according to a selected one of the metrics based on the data stored in the database; and
generating a report that matches the selected metric to the output data metrics to the output data generated from the tournaments.

9. The method of claim 8, wherein the tournament data comprises one or more of: venue, prize, sponsor and tournament type.

10. The method of claim 8, wherein receiving output data comprises receiving the numbers of each sex of players who played in the tournament, and the geographical locations of the players.

11. The method of claim 8, wherein generating the report comprises returning counts for individual metrics to a user.

12. The method of claim 8, wherein the output data comprises any one or more of: number of players, scores, ranks, names/IDs, ages, profiles, sex, geographic location.

13. The method of claim 8, wherein the one or more metrics comprise any one or more of:
type of prize, monetary value of the prize, venue's seating capacity, location of the venue, time of day of tournament, sponsor's industry type.

14. The method of claim 8, further comprising:
a plurality of users operating the tournament generator to generate a plurality of tournaments unique to each user, wherein the output data for each tournament is assessable to the respective user operating the specific tournament;
combining the tournament data metrics and the output data from the tournaments generated by the users, and generating a global report accessible to the users and containing the combined tournament data metrics and output data.

15. The method of claim 14, wherein the metrics in the global report include one or more of:
venue metric, prize metric, tournament type and sponsor metric.

16. A system for generating electronic game tournaments comprising a processor and a memory having instructions stored thereon that when executed cause the processor to generate:
an input interface that prompts a user for tournament data;
an input interface that prompts the user for scoreboard data;
a computerized game tournament according to the tournament data;
a customized tournament scoreboard, customized for a tournament being operated, according to scoreboard data and data generated by the operation of the tournament;
a display of player information on the customized tournament scoreboard.

17. A system for generating a report of metrics from electronic game tournaments comprising a processor and a memory having instructions stored thereon that when executed cause the processor to generate:
an electronic tournament generator configured to receive tournament data and characterizations of some of the tournament data according to one or more metrics;
a plurality of computer based game tournaments;
output data about players participating in the tournaments;
a database of the tournament data and output data;
a prompt for a user to select a metric;
an organized version of the data according to a selected one of the metrics based on the data stored in the database; and
a report that matches the selected metric to the output data metrics to the output data generated from the tournaments.
